(19) United States
(12) Patent Application Publication
(10) Pub. No.: US 2023/0325374 A1
(43) Pub. Date: Oct. 12, 2023

(54) GENERATION METHOD AND INDEX CONDENSATION METHOD OF EMBEDDING TABLE

(71) Applicant: NEUCHIPS CORPORATION, Hsinchu City (TW)

(72) Inventors: Yu-Da Chu, Hsinchu County (TW); Ching-Yun Kao, Taipei City (TW); Juinn-Dar Huang, Hsinchu County (TW)

(73) Assignee: NEUCHIPS CORPORATION, Hsinchu City (TW)

(21) Appl. No.: 17/745,898

(22) Filed: May 17, 2022

(30) Foreign Application Priority Data
Apr. 7, 2022 (TW) 111113211

(51) Int. Cl. G06F 16/22

(52) U.S. Cl. CPC G06F 16/2255; G06F 16/2282; G06N 20/00

(57) ABSTRACT

A generation method and an index condensation method of an embedding table are disclosed. The generation method includes: establishing an initial structure of the embedding table corresponding to categorical data according to an initial index dimension; performing model training on the embedding table having the initial structure to generate an initial content; defining each initial index as one of an important index and a non-important index based on the initial content; keeping initial indices defined as the important index in a condensed index dimension; dividing, based on a preset compression rate, initial indices defined as the non-important index into at least one initial index group each mapped to a condensed index in the condensed index dimension; establishing a new structure of the embedding table according to the condensed index dimension; and performing the model training on the embedding table having the new structure to generate a condensed content.

### CROSS-REFERENCE TO RELATED APPLICATION

This application claims the priority benefit of Taiwanese application no. 111113211, filed on Apr. 7, 2022. The entirety of the above-mentioned patent application is hereby incorporated by reference herein and made a part of this specification.

### BACKGROUND

### Technical Field

The disclosure relates to machine learning/deep learning. In particular, the disclosure relates to a generation method of an embedding table and a condensation method of an embedding table for a recommendation model in deep learning.

### Description of Related Art

Deep learning/machine learning is widely applied in the field of artificial intelligence. In deep learning, a recommendation system may recommend audio and video streams based on, for example, personal information and historical data of a user. The recommendation system has a plurality of embedding tables, and each embedding table includes a plurality of indices and at least one feature. Since the size of the embedding table is related to the number of data categories corresponding to the number of indices, when the embedding table is applied in a scenario with a relatively great amount of data, the excessively great scale of the embedding table is likely to increase the inference time of a neural network, and insufficient memory capacity is likely to result from a great amount of memory being occupied. Therefore, the embedding table has a need for data compression. How to condense/compress the embedding table to reduce the amount of data without compromising accuracy of the recommendation system is one of many technical issues in the field of artificial intelligence.

### SUMMARY

The disclosure provides a generation method and an index condensation method of an embedding table to generate an embedding table having an adapted index dimension.

An embodiment of the disclosure provides a generation method of an embedding table. The generation method includes the following. An initial structure of an embedding table corresponding to categorical data is established according to an initial index dimension. The initial index dimension includes a plurality of initial indices. Model training is performed on the embedding table having the initial structure to generate an initial content of the embedding table. Each initial index is defined as one of an important index and a non-important index based on the initial content of the embedding table. The plurality of initial indices defined as the important index are kept in a condensed index dimension. The plurality of initial indices defined as the non-important index are divided into at least one initial index group based on a preset compression rate. Each initial index group is mapped to a condensed index in the condensed index dimension. A new structure of the embedding table is established according to the condensed index dimension. The model training is performed on the embedding table having the new structure to generate a condensed content of the embedding table.

An embodiment of the disclosure provides an index condensation method of an embedding table. The index condensation method includes the following. An initial content of an embedding table having an initial index dimension is received. The initial index dimension includes a plurality of initial indices. Each initial index is defined as one of an important index and a non-important index based on the initial content of the embedding table. The plurality of initial indices defined as the important index are kept in a condensed index dimension. The plurality of initial indices defined as the non-important index are divided into at least one initial index group based on a preset compression rate. Each initial index group is mapped to a condensed index in the condensed index dimension. A new structure of the embedding table is established according to the condensed index dimension. Model training is performed on the embedding table having the new structure to generate a condensed content of the embedding table.

Based on the foregoing, in some embodiments of the disclosure, it is possible to calculate the condensed index dimension (adapted index dimension) based on the initial content of the embedding table, and then re-establish the new structure of the embedding table according to the condensed index dimension. The model training may be performed again on the embedding table having the new structure to generate the condensed content of the embedding table. In other words, in some embodiments, it is possible to determine the adapted index dimension of the embedding table through the model training. Accordingly, the accuracy of the recommendation system and the amount of data of the embedding table are both taken into account.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram showing an embedding table according to an embodiment of the disclosure.

FIG. 2 is a schematic diagram showing a generation method of an embedding table according to an embodiment of the disclosure.

FIG. 3 is a schematic flowchart of a generation method of an embedding table according to an embodiment of the disclosure.

FIG. 4 is a schematic diagram showing a mapping process of an embedding table according to an embodiment of the disclosure.

FIG. 5 is a flowchart of a generation method of an embedding table according to an embodiment of the disclosure.

FIG. 6 is a flowchart of an index condensation method of an embedding table according to an embodiment of the disclosure.

### DESCRIPTION OF THE EMBODIMENTS

The term “coupling (or connection)” as used throughout this specification (including the claims) may refer to any direct or indirect means of connection. For example, if it is herein described that a first device is coupled (or connected) to a second device, it should be interpreted that the first device may be directly connected to the second device, or the first device may be indirectly connected to the second device through other devices or some connection means. In addition, wherever possible, elements/members/steps using the same reference numerals in the drawings and embodiments denote the same or similar parts. Cross-reference may be made between relevant descriptions of elements/members/steps using the same reference numerals or using the same terms in different embodiments.

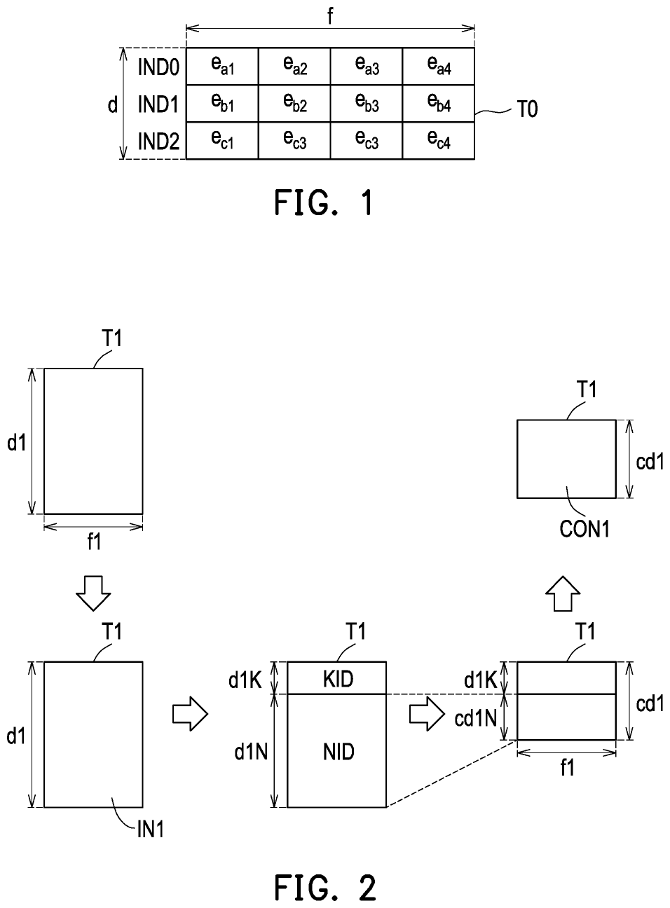

FIG. 1 is a schematic diagram showing an embedding table according to an embodiment of the disclosure. In deep learning, a recommendation system may include a plurality of embedding tables. With reference to FIG. 1, for example, an embedding table T0 among the plurality of embedding tables includes three indices, namely an index IND0, an index IND1, and an index IND2. Each of the indices includes four features. For example, the index IND0 includes a feature eₐ₁, a feature eₐ₂, a feature eₐ₃, and a feature eₐ₄; the index IND1 includes a feature e_{b1}, a feature e_{b2}, a feature e_{b3}, and a feature e_{b4}; and the index IND2 includes a feature eel, a feature ea, a feature e_{c3}, and a feature e_{c4}. In other words, in the embedding table T0 of this embodiment, an index dimension d is 3, and a feature dimension f is 4. The embedding table T0 only serves for exemplifying. In the recommendation system, the quantity of the embedding table, the index dimension of the embedding table, and the feature dimension of the embedding table are not limited by the disclosure.

The recommendation system of the disclosure may be constructed by an artificial neural network (ANN). The relevant functions of the recommendation system may be realized by programming codes, for example, general programming languages (e.g., C, C++, or assembly languages) or other suitable programming languages. The programming code may be recorded or stored in a recording medium. For example, the recording medium includes read only memory (ROM), storage device, and/or random access memory (RAM). The programming code may be read and executed from the recording medium by a processor (not shown) to achieve the relevant functions of the recommendation system. The processor may be disposed in, for example, a desktop computer, a personal computer (PC), a portable terminal product, a personal digital assistant (PDA), a tablet PC, or the like. In addition, the processor may include a central processing unit (CPU) with image data processing and computing functions, or any other programmable general-purpose or special-purpose microprocessor, digital signal processor (DSPs), image processing unit (IPU), graphics processing unit (GPU), programmable controller, application specific integrated circuit (ASIC), programmable logic device (PLD), and other similar processing devices, or a combination thereof. A “non-transitory computer readable medium”, for example, a tape, a disk, a card, a semiconductor memory, a programmable logic circuit, or the like, may serve as the recording medium. Moreover, the programming codes may also be provided to a computer (or CPU) through any transmission medium (communication network, radio waves, or the like). The communication network is, for example, the Internet, wired communication, wireless communication, or other communication media.

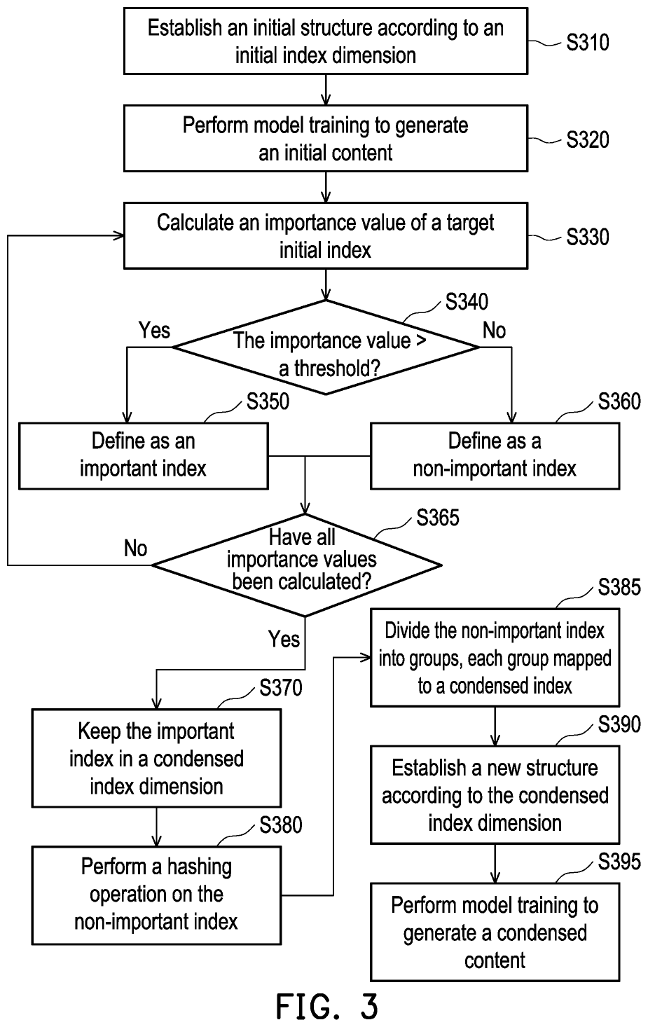

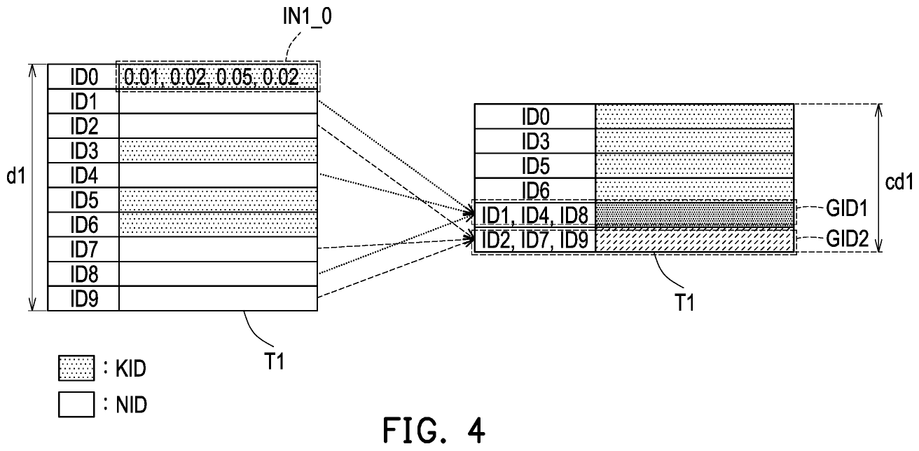

FIG. 2 is a schematic diagram showing a generation method of an embedding table according to an embodiment of the disclosure. FIG. 3 is a schematic flowchart of a generation method of an embedding table according to an embodiment of the disclosure. FIG. 4 is a schematic diagram showing a mapping process of an embedding table according to an embodiment of the disclosure. With reference to FIG. 3, together with FIG. 2 and FIG. 4, in step S310 of FIG. 3, a processor receives a plurality of categorical data, and establishes an initial structure of each of a plurality of embedding tables corresponding to the categorical data according to an initial index dimension. The initial index dimension of each of the embedding tables includes a plurality of initial indices, and the initial index dimensions of the embedding tables may be the same or different. Specifically, the categorical data (in the original data set) may serve to construct the plurality of embedding tables to be provided to the recommendation system for an operation. In FIG. 2, the processor establishes the initial structure of an embedding table T1 corresponding to the categorical data according to an initial index dimension d1. With reference to FIG. 2, the initial structure of the embedding table T1 includes f1 columns and d1 rows, for example, where the f1 columns correspond to a feature dimension f1, and the d1 rows correspond to the initial index dimension d1. In other words, the initial index dimension d1 includes d1 initial indices. Regarding the initial index dimension d1, taking FIG. 4 as an example, the initial index dimension d1 of the embedding table T1 is 10, for example. In other words, the initial index dimension d1 includes ten initial indices, i.e., an initial index ID0, an initial index ID1, an initial index ID2, an initial index ID3, an initial index ID4, an initial index ID5, an initial index ID6, an initial index ID7, an initial index ID8, and an initial index ID9.

With reference back to FIG. 3, in step S320, the processor performs model training on the embedding table T1 having the initial structure to generate an initial content IN1 of the embedding table T1, as shown in FIG. 2. In this embodiment, the model training, for example, is common training in machine learning/deep learning. For example, the minimum cost function is calculated in iterations according to training conditions to accordingly obtain the trained initial content IN1. With reference to FIG. 4, the initial content IN1 may include a plurality of trained values respectively corresponding to the initial index ID0 to the initial index ID9. For example, an initial content IN1_0 corresponding to the initial index ID0 may include trained values 0.01, 0.02, 0.05, and 0.02. The initial content IN1 may serve for weight calculation of an ANN, for example, but the disclosure is not limited thereto.

In step S330, the processor calculates an average or a root mean square of the initial content IN1 of a target initial index among the plurality of initial indices to serve as an importance value α of the target initial index. Taking FIG. 4 as an example, the processor may first take the initial index ID0 as the target initial index, where the initial index ID0 corresponds to the initial content IN1_0. Next, the processor calculates the average or the root mean square of the trained values 0.01, 0.02, 0.05, and 0.02 in the initial content IN1_0 to serve as an importance value α0 of the initial content IN1_0. For example, when the target initial index is the initial index ID0, the processor calculates that the importance value α0 corresponding to the initial index ID0 is 0.029 by performing the root mean square operation on the four trained values 0.01, 0.02, 0.05, and 0.02 in the initial content IN1_0 corresponding to the initial index ID0. The calculation of taking the average or the root mean square to serve as the importance value α is only an example. In other embodiments, other statistical manners may also serve for the calculation of the importance value for performing importance analysis for the plurality of initial indices of the embedding table.

Next, in step S340, after calculating the importance value of the target initial index, the processor may compare the importance value α of the target initial index and a given threshold TH. When the importance value α of the target initial index is greater than the threshold TH, the flow enters step S350. When the importance value α of the target initial index is less than the threshold TH, the flow enters step S360. In step S350, the processor defines the target initial index as an important index KID. In step S360, the processor defines the target initial index as a non-important index NID. With reference to FIG. 2, the processor may define the target index as one of the important index KID or the non-important index NID according to the comparison result obtained by comparing the importance value α and the threshold TH.

Next, in step S365, the processor determines whether the importance values of all the initial indices have been calculated. If so, the flow enters step S370. If not, the flow returns to step S330. Specifically, the processor determines whether all the initial indices, for example, the initial index ID0 to the initial index ID9, have been alternately taken as the target initial index for calculating the importance values thereof, for example, sequentially calculating the importance value α0 to an importance value α9 corresponding to the initial index ID0 to the initial index ID9. If all the importance values have not been calculated, the process may return to step S330 to switch the target initial index to calculate the importance values of other initial indices until the processor has calculated the importance value α0 to the importance value α9 corresponding to the initial index ID0 to the initial index ID9.

For the important index KID and the non-important index NID, reference may be made to FIG. 2. The important index KID corresponds to an index dimension d1K, the non-important index NID corresponds to an index dimension d1N, and the initial index dimension d1 is the sum of the index dimension d1K and the index dimension d1N. Taking FIG. 4 as an example, if the importance value α0 corresponding to the initial index ID0 is 0.029 and the threshold TH is 0.02, the initial index ID0 may be defined as the important index KID since the importance value α0 is greater than the threshold TH. Comparatively, if an importance value α1 corresponding to the initial index ID1 is 0.012 and an importance value α2 corresponding to the initial index ID2 is 0.015 (not shown), for example, the initial index ID1 and the initial index ID2 may be defined as the non-important index NID since the importance value α1 and the importance value α2 are less than the threshold TH. By analogy, in the example of FIG. 4, the initial index ID0, the initial index ID3, the initial index ID5, the initial index ID6 are defined as the important index KID; and the initial index ID1, the initial index ID2, the initial index ID4, the initial index ID7, the initial index ID8, and the initial index ID9 are defined as the non-important index NID. The value of the threshold TH may be adjusted depending on the actual design requirements, or a specific percentage of the plurality of importance values a may also be obtained as the value the threshold TH, and the disclosure is not limited thereto.

In step S370, the processor may keep the plurality of initial indices defined as the important index KID in a condensed index dimension cd1 without condensing/compressing the plurality of initial indices defined as the important index KID. Taking FIG. 4 as an example, since the initial index ID0, the initial index ID3, the initial index ID5, and the initial index ID6 are defined as the important index KID, it means that the data of these indices is relatively important, and performing condensation/compression thereon may affect the accuracy of the recommendation system. Therefore, the processor keeps the important index KID, that is, does not condense/compress the initial index ID0, the initial index ID3, the initial index ID5, and the initial index ID6. From FIG. 2, the processor keeps the index dimension d1K corresponding to the important index KID as the index dimension d1K in the condensed index dimension cd1 without condensing/compressing the plurality of initial indices defined as the important index KID.

In step S380, the processor performs a hashing operation on each initial index defined as the non-important index NID based on a preset compression rate to generate a hash value of each initial index defined as the non-important index NID. In this embodiment, the hashing operation is a modulo operation and the hash value is a modulo, for example but not limited thereto. For example, hashing operations on the initial index ID1, the initial index ID2, the initial index ID4, the initial index ID7, the initial index ID8, and the initial index ID9 each generate a modulo. Since the value of the modulo after the hashing operation is lower than the original value before the hashing operation, the amount of data of the non-important index NID can be reduced.

Next, in step S385, the processor divides the plurality of initial indices defined as the non-important index NID into at least one initial index group according to the hash value of each initial index, where each initial index group is mapped to a condensed index in the condensed index dimension cd1. The sum of the index dimensions corresponding to the at least one index group is equal to a condensed index dimension cd1N, and the number of divided groups (corresponding to the condensed index dimension cd1N) is equal to the value of the index dimension d1N divided by the preset compression rate. Taking FIG. 4 as an example, the processor may divide the initial index ID1, the initial index ID2, the initial index ID4, the initial index ID7, the initial index ID8, the initial index ID9 defined as the non-important index NID into groups according to the modulo. Assuming that the preset compression rate is 3 times, the number of divided groups is equal to the index dimension d1N divided by the preset compression rate, that is, the number of divided groups is equal to 6/3=2. For example, two initial index groups, i.e., an initial index group GID1 and an initial index group GID2 are included.

For example, the initial index ID1, the initial index ID4, and the initial index ID8 have the same modulo, or have a common feature of modulo, so they are divided into the initial index group GID1. The initial index ID2, the initial index ID7, and the initial index ID9 have the same modulo, or have a common feature of modulo, so they are divided into the initial index group GID2. In other words, the initial index ID1, the initial index ID2, the initial index ID4, the initial index ID7, the initial index ID8, and the initial index ID9 are divided into the initial index group GID1 and the initial index group GID2 according to the modulo.

In step S390, the processor establishes a new structure of the embedding table T1 according to the condensed index dimension cd1. In this embodiment, with reference to FIG. 2, the new structure of the embedding table T1 includes f1 columns and cd1 rows, for example, where the f1 columns correspond to the feature dimension f1, and the cd1 rows correspond to the condensed index dimension cd1. In other words, the condensed index dimension cd1 includes cd1 condensed indices. Regarding the condensed index dimension cd1, taking FIG. 4 as an example, the condensed index dimension cd1 of the embedding table T1 is 6. In other words, the condensed index dimension cd1 includes six condensed indices, i.e., the initial index ID0, the initial index ID3, the initial index ID5, the initial index ID6, the initial index group GID1, and the initial index group GID2. In addition, the initial index group GID1 includes the initial index ID1, the initial index ID4, and the initial index ID8, and the initial index group GID2 includes the initial index ID2, the initial index ID7, and the initial index ID9.

Next, in step S395, the processor may perform model training on the embedding table T1 having the new structure to generate a condensed content CON1 of the embedding table T1. With reference to FIG. 2, model training on the embedding table T1 having the new structure generates the condensed content CON1. Taking FIG. 2 and FIG. 4 as an example, the initial index dimension d1 corresponding to the corresponding initial content IN1 of the embedding table T1 may be 10, and the condensed index dimension cd1 corresponding to the condensed content CON1 of the embedding table T1 is 6. In other words, the index dimension of the condensed content CON1 of the embedding table T1 is compressed to 60% relative to the initial content IN1. The same or different training methods may be adopted as the model training in step S395 and step S320, and the disclosure is not limited thereto.

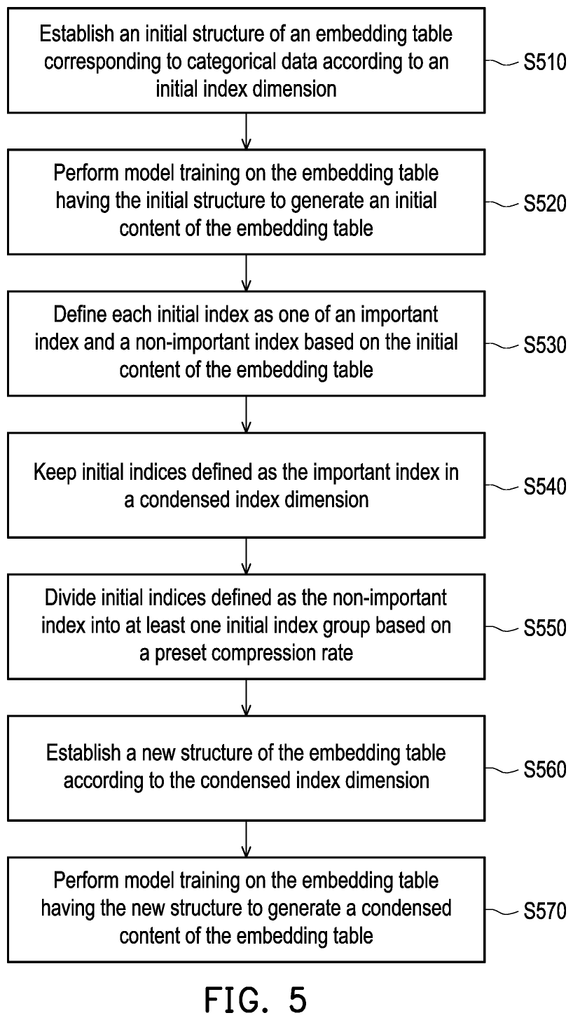

FIG. 5 is a flowchart of a generation method of an embedding table according to an embodiment of the disclosure. With reference to FIG. 5, in step S510, a processor establishes an initial structure of an embedding table corresponding to categorical data according to an initial index dimension. The initial index dimension of each embedding table includes a plurality of initial indices. Next, in step S520, the processor performs model training on the embedding table having the initial structure to generate an initial content of the embedding table. In step S530, the processor defines each initial index as one of an important index and a non-important index based on the initial content of the embedding table. Next, in step S540, the processor keeps the plurality of initial indices defined as the important index in a condensed index dimension. In step S550, the processor divides the plurality of initial indices defined as the non-important index into at least one initial index group based on a preset compression rate. Each initial index group is mapped to a condensed index in the condensed index dimension. Next, in step S560, the processor establishes a new structure of the embedding table according to the condensed index dimension. In step S570, the processor performs model training on the embedding table having the new structure to generate a condensed content of the embedding table.

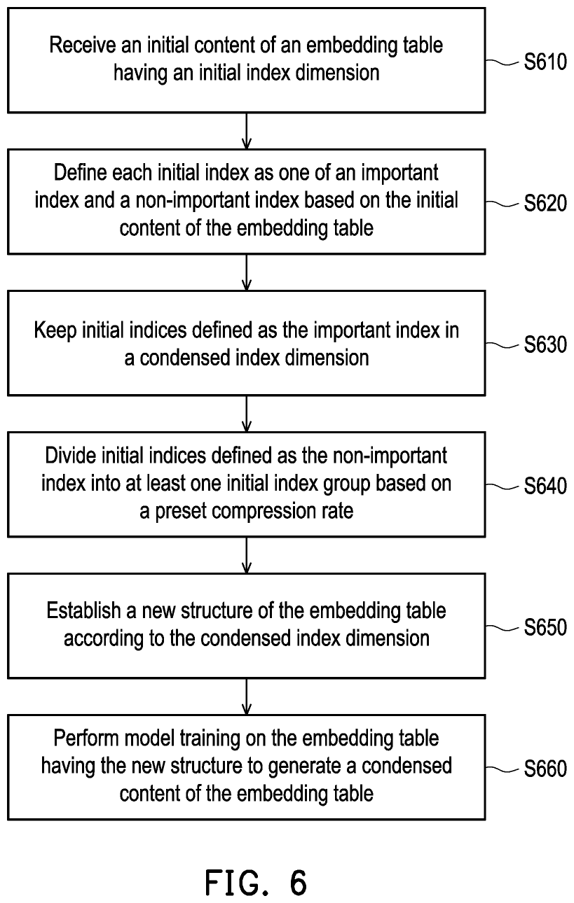

FIG. 6 is a flowchart of an index condensation method of an embedding table according to an embodiment of the disclosure. With reference to FIG. 6, in step 610, a processor receives an initial content of an embedding table having an initial index dimension. The initial index dimension includes a plurality of initial indices. In step S620, the processor defines each initial index as one of an important index and a non-important index based on the initial content of the embedding table. Next, in step S630, the processor keeps the plurality of initial indices defined as the important index in a condensed index dimension. In step S640, the processor divides the plurality of initial indices defined as the non-important index into at least one initial index group based on a preset compression rate. Each initial index group is mapped to a condensed index in the condensed index dimension. Next, in step S650, the processor establishes a new structure of the embedding table according to the condensed index dimension. In step S660, the processor performs model training on the embedding table having the new structure to generate a condensed content of the embedding table.

In summary of the foregoing, in some embodiments of the disclosure, it is possible to calculate the condensed index dimension (adapted index dimension) based on the initial content of the embedding table, and then re-establish the new structure of the embedding table according to the condensed index dimension. The model training may be performed again on the embedding table having the new structure to generate the condensed content of the embedding table. In other words, in some embodiments, it is possible to determine the adapted index dimension of the embedding table through the model training. Accordingly, the accuracy of the recommendation system and the amount of data of the embedding table are both taken into account to improve efficiency in operations and save training time and hardware costs. Moreover, the amount of data of the non-important index can be reduced by the hashing operation. Furthermore, reduction in the index dimension also mitigates over-fitting.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A generation method of an embedding table, comprising:
establishing an initial structure of an embedding table corresponding to categorical data according to an initial index dimension, wherein the initial index dimension comprises a plurality of initial indices;
performing model training on the embedding table having the initial structure to generate an initial content of the embedding table;
defining each of the plurality of initial indices as one of an important index and a non-important index based on the initial content of the embedding table;
keeping the plurality of initial indices defined as the important index in a condensed index dimension;
dividing the plurality of initial indices defined as the non-important index into at least one initial index group based on a preset compression rate, wherein each of the at least one initial index group is mapped to a condensed index in the condensed index dimension;
establishing a new structure of the embedding table according to the condensed index dimension; and
performing the model training on the embedding table having the new structure to generate a condensed content of the embedding table.

2. The generation method according to claim 1, wherein defining each of the plurality of initial indices as one of the important index and the non-important index comprises:
calculating an importance value of a target initial index among the plurality of initial indices based on the initial content of the target initial index; and
defining the target initial index as one of the important index and the non-important index according to the importance value.

3. The generation method according to claim 2, wherein calculating the importance value of the target initial index comprises:
calculating an average or a root mean square of the initial content of the target initial index to serve as the importance value of the target initial index.

4. The generation method according to claim 2, wherein defining the target initial index as one of the important index and the non-important index comprises:
comparing the importance value of the target initial index with a threshold;
defining the target initial index as the important index when the importance value is greater than the threshold; and
defining the target initial index as the non-important index when the importance value is less than the threshold.

5. The generation method according to claim 1, wherein dividing the plurality of initial indices defined as the non-important index into the at least one initial index group comprises:
performing a hashing operation on each of the plurality of initial indices defined as the non-important index based on the preset compression rate to generate a hash value of each of the plurality of initial indices defined as the non-important index; and
dividing the plurality of initial indices defined as the non-important index into the at least one initial index group according to the hash values.

6. An index condensation method of an embedding table, comprising:
receiving an initial content of an embedding table having an initial index dimension, wherein the initial index dimension comprises a plurality of initial indices;
defining each of the plurality of initial indices as one of an important index and a non-important index based on the initial content of the embedding table;
keeping the plurality of initial indices defined as the important index in a condensed index dimension;
dividing the plurality of initial indices defined as the non-important index into at least one initial index group based on a preset compression rate, wherein each of the at least one initial index group is mapped to a condensed index in the condensed index dimension;
establishing a new structure of the embedding table according to the condensed index dimension; and
performing model training on the embedding table having the new structure to generate a condensed content of the embedding table.

7. The index condensation method according to claim 6, wherein defining each of the plurality of initial indices as one of the important index and the non-important index comprises:
calculating an importance value of a target initial index among the plurality of initial indices based on the initial content of the target initial index; and
defining the target initial index as one of the important index and the non-important index according to the importance value.

8. The index condensation method according to claim 7, wherein calculating the importance value of the target initial index comprises:
calculating an average or a root mean square of the initial content of the target initial index to serve as the importance value of the target initial index.

9. The index condensation method according to claim 7, wherein defining the target initial index as one of the important index and the non-important index comprises:
comparing the importance value of the target initial index with a threshold;
defining the target initial index as the important index when the importance value is greater than the threshold; and
defining the target initial index as the non-important index when the importance value is less than the threshold.

10. The index condensation method according to claim 6, wherein dividing the plurality of initial indices defined as the non-important index into the at least one initial index group comprises:
performing a hashing operation on each of the plurality of initial indices defined as the non-important index based on the preset compression rate to generate a hash value of each of the plurality of initial indices defined as the non-important index; and
dividing the plurality of initial indices defined as the non-important index into the at least one initial index group according to the hash values.
